(19) United States
(12) Patent Application Publication
(10) Pub. No.: US 2008/0038977 A1
(43) Pub. Date: Feb. 14, 2008

(54) Alkyd resins as non-formaldehyde binders for nonwoven products

(75) Inventors: Jan Lebduska, Pandubien (CZ); Robert Schmidt, Thornhill (CA); Elena Pisanova, Mississauga (CA); Hendrikus van Herwijnen, Hausleiten-Goldgeben (AT); Stefan Kowatsch, Grobheinrichschlag (AT)

Correspondence Address: BIRCH STEWART KOLASCH & BIRCH, PO BOX 747, FALLS CHURCH, VA, 22040-0747, US

(73) Assignee: Dynea Oy, Helsinki (FI)

(21) Appl. No.: 11/889,066

(22) Filed: Aug. 8, 2007

Related U.S. Application Data
(60) Provisional application No. 60/836,383, filed on Aug. 9, 2006.

(51) Int. Cl. D04H 13/00; B01F 3/08; B05D 3/02

(52) U.S. Cl. 442/327; 427/385.5; 427/389.7; 516/53

(57) ABSTRACT

Curable formaldehyde-free aqueous binders comprising alkyd resin dispersions or hybrid alkyd-acrylic resin dispersions that are useful in producing nonwoven products such as fiberglass insulation, roofing glass mats and filtration materials.

This Nonprovisional application claims priority under 35 U.S.C. §119(e) on U.S. Provisional Application No. 60/836,383 filed on Aug. 9, 2006, the entire contents of which are hereby incorporated by reference.

### FIELD OF THE INVENTION

The present invention relates to non-woven binder compositions containing an aqueous alkyd resin emulsion. These binders are useful for the manufacture of nonwoven products including glass fiber, polyester fiber and mineral wool products, such as insulation materials, roofing glass fiber mats, filters and the like.

### BACKGROUND OF THE INVENTION

Phenol-formaldehyde (PF) binders have been the primary binders in the manufacture of fiberglass and mineral wool insulation. Urea-Formaldehyde (UF) binders are widely used in filters and roofing mats production. These binders are inexpensive, easy to apply and readily cured. They provide a strong bond, and yet maintain elasticity and a good thickness recovery to obtain a full insulating value. However, there is a strong desire in the market for a binder based on chemistry other than formaldehyde.

A serious disadvantage of formaldehyde-based resins is that they emit formaldehyde into the surrounding environment. Due to environmental, health, and regulatory issues related to formaldehyde emissions, there is a continuing need for alternative formaldehyde-free binders.

Although a number of formaldehyde-free compositions have been developed, there still exists a need for alternative fiberglass binder systems that provide the performance advantages of PF and UF resins in a formaldehyde-free system.

A number of formaldehyde-free compositions have been developed for use as a binder for making nonwoven products.

U.S. Pat. No. 4,076,917 discloses the use of beta-hydroxyalkylamides to cure polycarboxy polymers such as polyacrylic acid. Such a system, however, is too viscous for use as a fibrous glass binder.

U.S. Pat. No. 5,143,582 discloses heat-resistant nonwovens containing ammonia-neutralized polycarboxylic acids, either monomeric or polymeric, and beta-hydroxyalkylamides. However, the binder compositions are believed to liberate ammonia upon cure. Ammonia emissions are becoming increasingly tightly regulated.

U.S. Pat. Nos. 6,221,973 and 6,331,350 describe a formaldehyde-free fiberglass binder including a polyacid, such as polyacrylic acid, and a polyol, with a molecular weight less than about 1000, such as, for example, glycerol, triethanolamine, sorbitol, or ethylene glycol. A phosphorous catalyst is used to accelerate the cure of the composition. Drawbacks of this binder include low pH causing corrosion of metal parts along the production lines, and high cure temperature.

WO 03/104284 describes an epoxide-type formaldehyde-free insulation binder containing a substantially infinitely water-dilutable or water-dispersible mixture of an epoxide and a multi-functional cross-linker, such as polyamidoamine polymer. Practical use of such a binder is limited by its high cost.

Despite these disclosures, there is a growing need for new formaldehyde-free aqueous compositions suitable for use as a binder for fiberglass insulation, roofing and filtration materials.

Alkyd resins have been used extensively in the production of protective and decorative coatings industry. In the present invention, the term “alkyd resin” is used to describe a polyester resin produced from the reaction of a polyhydric alcohol(s), polybasic acid(s) and a monobasic fatty acid(s) or oil(s). In the present invention, the alkyd resin is in the form of an aqueous emulsion, which cures via dehydration and free radical reactions. These systems possess several advantages over conventional systems including being derived from renewable resources, use no formaldehyde in their production, produce no formaldehyde during their processing and can be tailored to yield a wide range of performance properties. While as a class of polymer they have been produced commercially for quite some time and uses as protective finishes and coatings, they have not been described as binders for non-wovens applications previously. An exception is a German patent issued in 1966 describing the use of alkyd resins in a combination with formaldehyde-based resin for non-woven applications.

German patent DE 1,594,948, also included into British patent GB 1,151,152 describes fiberglass binders consisting of a mixture or a pre-condensate of an alkyd resin, an etherified aminoplast resin (e.g., methylolmelamine), and a tertiary amine. The amine imparts water solubility to the hybrid binder, which is suitable for application by spraying, coating or saturation to various non-woven fibrous materials, such as textile floor covering or filtering media. However, using formaldehyde-based aminoplast resin in the composition would result in formaldehyde emission during its cure. Therefore, a further research is needed toward formaldehyde-free alkyd resins that could be used as binders for fibrous materials.

An obvious disadvantage of alkyd resins restricting their usage as non-wovens binders is softness of the cured polymer. Although alkyd resins are excellent film-formers, they cure to produce relatively soft and flexible films. This can be explained by the presence of flexible fatty acid chains incorporated into the cured polymer. Longer fatty acid chains and higher percentage of fatty acid in the alkyd composition result in higher softness of the cured resin. On the contrary, a successful non-wovens binder cures to form a rigid solid polymer, which provides good mechanical properties, e.g., recovery and rigidity of the final product.

Another disadvantage of alkyd resins with respect to their potential use in non-wovens industry is their insolubility in water. Alkyd paints usually contain a suitable solvent (hexane or mineral spirits). However, the need to reduce the volatile organic content (VOC) of alkyds for environmental reasons has led to further research towards water-reducible alkyd resins.

Recently, several attempts have been made to develop water-reducible modified alkyd resins curing to a polymer network with higher strength, which would be suitable for applications different form coatings.

U.S. Pat. No. 5,196,459 describes a curable aqueous composition based on a modified alkyd resin, which is rendered water-soluble by neutralization with a base. Alkyd resins are modified by acrylated oil, or by maleated rosin esters. Such a modification results in greater degree of hardness and durability of the cured coating film. Additional advantage of using maleated rosin in combination with alkyd resin is increase in solids content up to 40% without affecting the viscosity of the composition.

U.S. Pat. No. 6,121,398 describes high modulus thermosetting polymers and composites derived from plant oils, such as soybean oil. Chemical modification of the oil using maleic anhydride gives maleinized oil that can be further co-polymerized with different active monomers to form a rigid solid resin or composite. Epoxidized and acrylated oils can be cured to highly cross-linked network polymers with high structural strength. Such resins can be used as polymer matrix materials in fiber-reinforced composites.

U.S. Pat. Nos. 6,803,439 and 6,884,838 describe fiberglass binder containing fatty acids. The binder comprises an aqueous solution of a polycarboxy polymer, a polyol and a fatty acid. The composition is sprayed onto glass fiber and cured at elevated temperatures in a presence of a catalyst, giving fiberglass insulation products with good recovery and rigidity. The fatty acid addition makes the insulation products resistant to water absorption.

These examples show that a proper modification of alkyd resins and their components such as oils and fatty acids can result in improved hardness and rigidity of the cured resin, which is important for the quality of non-woven products. However, the alkyd resins have not been described for the use as non-wovens binders yet.

Accordingly, it is an objective of the present invention to provide a novel, formaldehyde-free binder for non-wovens based on alkyd resins.

### SUMMARY OF THE INVENTION

The present invention relates to the use of an aqueous alkyd resin emulsion in the manufacture of nonwoven products, such as glass fiber products, polyester fiber products and mineral wool products, such as insulation products, roofing glass fiber mat products, filter products and the like.

An important aspect of the binder of the present invention is that it does not contain formaldehyde or organic solvents, which minimizes the volatile organic content (VOC). The binder contains vegetable oils that are a renewable raw material. Furthermore, the oils and fatty acids present in the binder impart the waterproof properties to the final product.

Alkyd resins of the present invention can be used unmodified as well as modified by acrylic dispersions. Hybrid alkyd-acrylic binder can be prepared (a) as a physical mixture of water-dispersible alkyd resins with acrylic dispersions, or (b) as a pre-condensate, in which case emulsion polymerization of acrylic monomers takes place in the presence of alkyd dispersion. A modification of alkyd resins by acrylic polymers provides hardness and strength to the cured polymer network and to the final non-woven products.

### DETAILED DESCRIPTION OF THE INVENTION

The following detailed description and examples are given in an effort to those desiring to practice the present invention, and as such should not be deemed to unduly limit the present invention or the equivalents encompassed thereby as set forth in the claims appended hereto, and the equivalents encompassed thereby. In this respect, those of ordinary skill in the art will realize that various minor changes may be made in the materials, procedures and methods set forth herein, without departing from the spirit or scope of the present invention.

The present invention relates to the use of an aqueous alkyd resin emulsion as a binder composition in the manufacture of non-woven articles.

In the present invention, the term “non-woven article” relates to products such as glass fiber products, polyester fiber products and mineral wool products, for example insulation products, roofing glass fiber mat products, filter products and the like.

The key component of the binder composition of the present invention is the alkyd emulsion. This is produced in two discrete steps: formation of the alkyd resin and subsequent emulsification. Methods for preparing the alkyd emulsion are well known to those skilled in the art and involve the reaction of three primary components in varying compositions under appropriate conditions with or without the addition of modifiers. The three primary components are a polyol component, a polyacid component and a fatty acid and/or oil component.

Suitable polyols include but are not restricted to glycerol, pentaerythritol, dipentaerythritol, trimethylolethane, trimethylolpropane, ethylene glycol, propylene glycol, neopentylene glycol and dipropylene glycol or combinations thereof. Preferred polyols are glycerol, ethylene glycol and pentaerythritol.

The polyacids of the present invention are relatively low molecular weight (<250) and have more than one acid moiety on the molecule. Suitable polyacids include but are not restricted to phthalic anhydride, isophthalic acid, maleic anhydride, fumaric acid, azelaic acid, succinic acid, adipic acid and sebacic acid or combinations thereof.

Suitable oils include but are not restricted to linseed, soybean, dehydrated castor, peanut, tung, fish, safflower, cottonseed, coconut or combinations. Fatty acids can be obtained whole or fractionated from the oils described above. Fatty acids derived from tall oil are also suitable in the present invention. In addition, synthetic saturated and unsaturated fatty acids can be used including oleic, octanoic, caproic, pelargonic, isodecanoic, isooctanoic, 2-ethylhexanoic or combinations. The degree of saturation of the fatty acid/oil component can be tailored to achieve the desired performance properties.

It is believed that the degree of saturation of the fatty acid/oil component affects the properties of the final alkyd resin. Fatty acids with lower degree of saturation have more double bonds (—C═C—). These double bonds are reactive and work as additional cross-linkers at the cure of the composition. Thus, at a lower degree of saturation, one would expect (a) a higher cure speed and (b) higher cross-link density resulting in higher rigidity and toughness of the cured product. On the contrary, a higher degree of saturation will result in slower cure and softer and flexible cured product.

Modifiers may be added to the main components to change specific performance or cost properties. Alkyd resins are rich in hydroxyl and carboxyl groups, and therefore can be co-cured (co-reacted) with the modifiers. The modifiers are selected of water-soluble or water-dispersible compounds able to co-cure with alkyd resins producing a hard and durable thermosetting polymer. These modifiers could comprise anywhere from 1-50% of the liquid weight of the resin. Common modifiers could include acrylic dispersions, isocyanates, epoxides, amines, polyamides, rosin acids, rosin esters, silanes, acrylonitrile, or combinations thereof.

For example, the addition of a polyacrylic dispersion makes the resulting (cured) network harder, which is important for several applications (generally, cured alkyds form soft and flexible polymer films). The probable reason for increased rigidity is co-reaction of alkyd and acrylic components, and as a result, the cured polymer has higher cure density which affects both rigidity and toughness.

To produce the alkyd resin, the three primary components (polyol, polybasic acid and oil/fatty acid) are combined and heated under agitation to a reaction temperature of between 200-300° C., preferably between 210-250° C. when solely a fatty acid is used and 210-280° C. when a combination of fatty acid and oil are used. The mixture is maintained in this range until the desired molecular weight distribution is achieved. The appropriate cut-off point is typically determined by acid number and viscosity. The acid number is less than 15 but preferably between 2 to 5. The acid number is defined as a number of milligrams of potassium hydroxide required to neutralize 1 gram of solid material. It is a measure of degree of esterification.

The viscosity of the alkyd resin ranges from 50 to 2,000 centipoise, preferably between 200-1,000 centipoise. The resulting resin is then cooled and combined with an appropriate emulsifier under agitation to produce a stable emulsion.

Emulsification can take place (a) through external means, with the addition of a polymerizable surfactant to the alkyd resin, or (b) through internal means, whereby the resin is anionic stabilized co-polymer of an alkyd and an acrylic monomer. Emulsifiers such as the Igepal type described in U.S. Pat. No. 3,440,193 (whose teachings of the emulsifiers are herein incorporated by reference) can be added to stabilize the emulsion formed. Also, stabilization of such a co-polymer can be achieved internally if the alkyd contains pendant quaternary functional groups. The emulsion droplet sizes typically range from 20-200 nm in size.

The resulting alkyd emulsion can then be modified through emulsion polymerization techniques to incorporate additional monomers containing unsaturated functional groups. These techniques are known to those skilled in the art.

The resin of the present invention further includes a catalyst, which facilitates the cross-linking reaction at the elevated temperatures used for the non-wovens production. Suitable catalysts are water-soluble salts of cobalt, barium, zirconium or their mixture. Commercial catalysts for the alkyds known by those knowledgeable in the art as “drying agents” can also be used. These catalysts (driers) promote auto-oxidation and crosslinking. They are generally mixtures of oil soluble salts of Co, Mn, Zr, Ca, or other metals, as described in R. W. Hein, J. Coat. Technol. 1999, 71(898), 21-25. For example, the catalyst Additol VXW 4940 contains approx. 3% Co; approx. 3% Ba, and approx. 5% Zr.

The binder used in the present invention is prepared simply by aqueous dilution of the alkyd emulsion to the desired level, incorporation of a selected modifier(s) or additive(s). The binder is then applied to the fibers used to produce non-woven articles. Prior to dilution the alkyd emulsion has a solid content of greater than 30 wt % based on the total weight of the alkyd emulsion. Preferably, the alkyd emulsion has a solid content of 35-50 wt %. Even more preferably, the alkyd emulsion has a solid content of 42-46% based on the total weight of the alkyd emulsion. The alkyd emulsion is then diluted to an amount sufficient to allow efficient application to the nonwoven fiber. For example, the alkyd emulsion is diluted to 3-7 wt % for mineral wool, 20-25% for roofing glass fiber mats, and is undiluted for air filter applications.

The alkyd based aqueous dispersions for making non-woven articles may be applied to glass, mineral wool or polymer fibers by conventional techniques.

The alkyd based aqueous dispersions, after they are applied to the fibers used in the production of non-woven articles are then heated and exposed to air oxygen, which results in the drying and curing of the aqueous thermosetting composition. The introduction of the oxygen may occur via gravity, forced gas or vacuum introduction. This reaction is a chain reaction that proceeds by a free-radical polymerization. A hydroperoxide is formed on an allylic methylene group in the fatty acid: 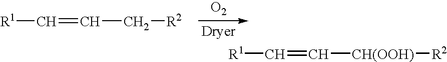
wherein R¹ and R² are moieties that make up known fatty acids. These hydroperoxides transform to radicals. Follow-up reactions, also with other molecules, lead to the formation of a 3-dimensional network. Fatty acids containing only one double bond are slowly auto-oxidized, whereas those containing a methylene group activated by 2 double bonds will react over 100 times faster.

The non-woven fiber is glass fiber, rock wool fiber, cellulose, wool, jute, polyester, acrylic, nylon, polyamide, and the like.

The curable aqueous binder composition can also include other components, e.g., anti-foaming agents, biocide additives, anti-mycotics including, e.g., fungicides and mold inhibitors, adhesion promoting agents, colorants, pigments, fillers, anti-migration aids, dust control aids, coalescents, wetting agents, waxes, antioxidants, corrosion inhibitors, fire retardants, and combinations thereof.

In an embodiment of the invention, the viscosity of the curable aqueous composition is reduced to improve its suitability for some industrial applications. In these compositions, low molecular weight extenders and/or viscosity modifiers can be added to improve processability of the binder.

Any viscosity modifier known in the art that is compatible with the curable aqueous composition can be used, but it is preferable to use low molecular weight polyols. The low molecular weight polyol is at least one selected from the group consisting of glucose, sucrose, sorbitol, glycerol, ethylene glycol, diethanolamine, triethanolamine, or the like. It is also envisioned to use additional water-soluble renewable materials, such as sugar alcohols or broken down natural polymers like dextrins as the viscosity modifiers. Preferably, the viscosity modifier is used in an amount of 35 to 80 parts based on 100 parts the alkyd resin, and most preferably, the viscosity modifier is used in an amount of 45 to 65 parts based on 100 parts the alkyd resin.

In an embodiment of the invention, the curable aqueous composition includes solvents other than water to promote intimate mixing of the components.

The curable aqueous composition of the invention can be used to prepare nonwoven products by a variety of methods known in the art, which, in general, involve the impregnation of a loosely assembled mass of fibers with the diluted curable aqueous solution to form a mat. The product can be used in agricultural/horticultural applications. Preferably the product is used in building insulation, a roofing fiberglass mat or a nonwoven filtration material.

For glass fiber products, the cured binder must provide a strong bond with sufficient elasticity and thickness recovery to permit reasonable shipping and in-service deformation. It also should be moisture resistant so that it does not swell under humid conditions. Additionally, it should be odor free and non-corrosive to metals with which it comes in contact. The cured polymer should be capable of withstanding high temperatures, particularly for pipe insulation where the pipeline is used for hot fluids.

Generally, fibers having a length of about ¼ inch to 3 inches and a diameter of about 3 to 20 microns are used in the wet-laid process (for example, roofing materials production).

Glass fibers typically used in manufacturing insulation products (that are produced using melt-blown technique) range in diameter from about 2 to 9 microns, and have a length of about ½ inch to 2 inches.

The particular method used for forming glass fibers for use in the present invention is relatively unimportant. Processes for making glass fiber products, especially glass fiber insulation products, using the curable aqueous composition of the present invention are typically carried out according to one of a number of methods wherein a molten mineral material flowing from a melting furnace is divided into streams and attenuated into fibers. The attenuation can be done by centrifuging and/or fluid jets to form discontinuous fibers of relatively small dimensions, which typically are collected by random depositing on a moving foraminous (porous) conveyor belt. The fibers are collected in a felted haphazard manner to form a mat or blanket. The volume of fiber in the mat or blanket will be determined by the speed of fiber formation and the speed of the belt.

Continuous glass fibers also may be employed in the form of mats or blankets fabricated by swirling the endless filaments or strands of continuous fibers, or they may be chopped or cut to shorter lengths for mat or blanket formation. Use can also be made of ultra-fine fibers formed by the attenuation of glass rods. Also, such fibers may be treated with a size, anchoring agent or other modifying agent before use.

Glass fiber products, including glass fiber insulation products, may also contain fibers that are not in themselves heat-resistant such as, for example, certain polyester fibers, rayon fibers, nylon fibers, and superabsorbent fibers, in so far as they do not materially adversely affect the performance of the product.

The curable aqueous composition may be applied to the glass fibers by conventional techniques such as, for example, air or airless spraying, padding, saturating, roll coating, curtain coating, beater deposition, and coagulation. For example, the curable aqueous composition can be applied to the glass fibers by flooding the collected mat or blanket of glass fibers and draining off the excess, by applying the binder composition onto the glass fibers during mat or blanket formation, by spraying the glass fiber mat or the like. It is preferred to spray the diluted alkyd resin binder onto the glass fibers at a concentration of 5%. The layer of fiber with binder is then mildly compressed and shaped into the form and dimensions of the desired glass fiber product, especially glass fiber insulation product, such as pipe, batt or board and passed through a curing oven (with or without hot air flow, but preferably with hot air flow) where the binder is cured, thus fixing the size and shape of the finished product by bonding the mass of fibers one to another and forming an integral composite structure.

In an embodiment of the invention, is a method for forming a non-woven material comprising: mixing nonwoven fibers with the curable aqueous binder composition comprising an alkyd resin emulsion, and heating the binder and fibers in oxygen. The duration and temperature of heating and exposure to oxygen affect the rate of cure and property development of the treated substrate. Heat treatment (curing) of the aqueous binder composition can take place from room temperature (about 23° C.) up to about 200° C. for a time period of from a few minutes (i.e. 5-10 minutes) up to an hour or more. It is envisioned that the fiber surface can be pretreated prior to application of the binder, e.g., with adhesion promoters, however, this is not preferred in view of the cost of this step.

On heating, the water present in the binder composition evaporates, and the binder composition undergoes curing. These processes can take place in succession or simultaneously. Curing in the present context is to be understood as meaning the chemical alteration of the composition, for example crosslinking through formation of covalent bonds between the various constituents of the composition, formation of ionic interactions and clusters, and/or formation of hydrogen bonds. Furthermore, the curing can be accompanied by physical changes in the binder, for example phase transitions or phase inversion.

As noted, the drying and curing functions may be accomplished in two or more distinct steps, if desired. For example, the composition may be first heated at a temperature and for a time sufficient to substantially dry but not to substantially cure the binder composition and then heated for a second time at a higher temperature and/or for a longer period of time to effect curing (crosslinking). Such a procedure, referred to as “B-staging”, may be used to provide a binder-treated glass fiber product, such as a glass fiber insulation product, for example, in roll form, which may at a later stage be cured, with or without forming or molding into a particular configuration, concurrent with the curing process. This processing makes it possible, for example, to use the compositions of this invention for producing binder-impregnated semifabricates that can be molded and cured elsewhere.

Glass fiber products can be formed as a relatively thin product of about 0.25 to 1.5 inch or it can be a thick mat or blanket of 12 to 14 inches or more. The time and temperature for cure will depend in part on the amount of binder in the final structure and the thickness and density of the structure that is formed.

The glass fiber products, and particularly the glass fiber insulation products may be used for applications such as, for example, insulation batts or rolls, as reinforcing mat for roofing or flooring applications, as roving, as microglass-based substrate for preparing laminated printed circuit boards or battery separators, as filter stock, as tape stock, and as reinforcement scrim in cementitious and non-cementitious coatings for masonry.

Unless otherwise indicated, all concentrations in weight percent as described herein are based on the entire weight of the composition.

The following examples are provided as an aid to those desiring to practice the present invention as disclosed herein but not to limit its scope.

### EXAMPLES

### Example 1

### Binder Preparation

Binder emulsion was prepared by adding a sufficient amount of Alkyd-Acrylic hybrid resin (CHS-Hydrospol D02, by Spolchemie, Czech Republic) and catalyst (Additol VXW 4940 by Spolchemie) to water and mixing to form a 5.0 wt % emulsion. The catalyst was used at 6 wt % (on binder solids). The binder was a milky opaque liquid of pH 7.9.

### Example 2

### Tensile Testing of Cured Glass Fiber Specimens

Binder of Example 1 was applied to a glass fiber substrate as follows.

Glass paper (Whatman 934-AH) was soaked in the binder solution for 5 minutes, then the excess liquid was removed by vacuum. The samples were put into an oven at 150-195° C. for 10-30 minutes (see Table 1) for curing of the binder resin.

The cured samples were cut into specimens having the dimensions of 6″×1″ and tested for dry tensile strength by placing them in the jaws of a Lloyd Instruments LRX Plus tensile tester. Samples were pulled apart at a crosshead speed of 2 inches/minute.

For wet tensile testing, the specimens were treated with hot water at 80 oC for 10 minutes, and then tested for tensile strength while still wet. Retention was calculated as a ration Wet strength/Dry Strength. Retention is a measure of the degree of cure of a curable composition: higher retention indicates higher degree of cross-linking. The load in Kgf was measured at the break. The test results are presented in the Table 1.

TABLE 1
Tensile Strength of Alkyd binder samples cured at different conditions

| Temperature, | | Dry strength, | Wet strength, | |
|---|---|---|---|---|
| ° C. | Time, min | kgf | kgf | Retention, % |
| 140 | 10 | 5.11 | 1.63 | 32 |
| 140 | 30 | 5.09 | 1.79 | 35 |
| 180 | 10 | 4.76 | 3.74 | 79 |
| 180 | 30 | 4.72 | 4.51 | 95 |
| 195 | 10 | 4.70 | 3.85 | 82 |

As can be seen from the Table 1, higher temperature and longer cure time result in higher degree of cure (wet strength and retention).

### Example 3

### LOI (Loss on Ignition) of Cured Glass Fiber Specimens

Specimens from Example 2 were tested for LOI at 650° C. for 10 minutes. “Dry LOI” (samples tested for dry tensile) and “Wet LOI” (samples after treatment with hot water) were determined. Samples for “Wet LOI” were dried before testing at 110° C. for 1 hr. The results are shown in the Table 2.

TABLE 2
LOI of Alkyd/Glass fiber samples cured at different conditions

| Temperature, ° C. | Time, min | Dry LOI, % | Wet LOI, % |
|---|---|---|---|
| 140 | 10 | 23.6 | 22.3 |
| 180 | 10 | 23.8 | 23.0 |

The results in the Table 2 show that even at relatively low temperatures and short cure times there was practically no uncured resin present in the samples. LOI data are consistent and show no binder loss after hot water treatment.

### Example 4

### Solubility of Cured Alkyd Resin

Alkyd resin was cured in an oven at 135° C. for 60 minutes. A piece of cured resin (weight 0.552 g) was treated with water at room temperature for 24 hours. No swelling or dissolution of the sample was observed. The sample was filtered out, dried at 110° C. for 1 hr, and reweighed. The final weight was 0.529 g, which corresponds to 96% cure.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A bonded nonwoven product prepared in a process comprising:
contacting nonwoven fibers with a curable aqueous binder composition comprising an alkyd resin emulsion; and
heating the mixture from 100° C. to 300° C. for sufficient time to affect a cure.

2. The bonded nonwoven product according to claim 1, wherein the nonwoven is at least one selected from the group consisting of glass fiber, polyester fiber and mineral wool.

3. The bonded nonwoven product according to claim 1, wherein the curable aqueous binder composition further comprises a modifier which is at least one selected from the group consisting of an acrylic dispersion, isocyanate, epoxide, amine, polyamide, rosin acid, rosin ester, silane and acrylonitrile.

4. The bonded nonwoven product according to claim 2, wherein the nonwoven is glass fiber.

5. A method of forming a bonded nonwoven product binder composition comprising:
contacting nonwoven fibers with a curable aqueous binder composition comprising an alkyd resin emulsion; and
heating the mixture from 100° C. to 300° C. for sufficient time to affect a cure.

6. The method according to claim 5, wherein the nonwoven is at least one selected from the group consisting of glass fiber, polyester fiber and mineral wool.

7. The method according to claim 5, wherein the curable aqueous binder composition further comprises a modifier which is at least one selected from the group consisting of an acrylic dispersion, isocyanate, epoxide, amine, polyamide, rosin acid, rosin ester, silane and acrylonitrile.

8. The method according to claim 6, wherein the nonwoven is glass fiber.

9. The method according to claim 5, further comprising
a step of forming the alkyd resin by reacting (a) a polyol, (b) polyacid and (c) a fatty acid or fatty acid ester to a viscosity of 50-2,000 centipoise; and
a step of emulsifying the alkyd resin.

10. The method according to claim 5, wherein the curable aqueous binder composition comprising an alkyd resin emulsion further comprises a catalyst.

11. The method according to claim 7, wherein the modifier is an acrylic dispersion.

12. The method according to claim 7, wherein the mixture of alkyd resin emulsion and acrylic dispersion is produced by co-polymerization in-situ.

13. The method according to claim 12, wherein the acrylic dispersion comprises 1-50% of the total binder composition by weight of solids.

14. The binder of claim 6 where said binder composition further comprises a catalyst selected of group consisting of water-soluble salts of cobalt, barium, zirconium or their mixture.

15. Building insulation material comprising the bonded nonwoven product of claim 1.

16. Roofing glass mat comprising the bonded nonwoven product of claim 1.

17. Filtration material comprising the bonded nonwoven product of claim 1.
